(19) United States
(12) Patent Application Publication
(10) Pub. No.: US 2014/0108030 A1
(43) Pub. Date: Apr. 17, 2014

(54) PHYSICIAN REFERRAL NETWORK

(71) Applicant: Adolfo Tejeda-Monteagut, Doral, FL (US)

(72) Inventor: Adolfo Tejeda-Monteagut, Doral, FL (US)

(21) Appl. No.: 13/842,602

(22) Filed: Mar. 15, 2013

Related U.S. Application Data
(60) Provisional application No. 61/712,759, filed on Oct. 11, 2012.

(51) Int. Cl. G06Q 10/10; G06Q 50/22

(52) U.S. Cl. CPC G06Q 10/1095; G06Q 50/22
USPC 705/2

(57) ABSTRACT

A system, method, and computer program product are provided for using a physician referral network to refer a patient from a physician to another healthcare provider. According to the method, there is received, via the physician referral network, a request from the physician for an appointment calendar of the other healthcare provider. The appointment calendar of the other healthcare provider is sent via the physician referral network to the physician. The appointment calendar includes information indicating days and times of open appointments. An appointment request is received via the physician referral network from the physician for an appointment for the patient with the other healthcare provider. The appointment request indicates the day and time of one of the open appointments from the appointment calendar of the other healthcare provider. After receiving the appointment request, a notification of the appointment with the other healthcare provider is sent to the patient. Both the physician and the other healthcare provider are registered members of the physician referral network.

### CROSS-REFERENCE TO RELATED APPLICATIONS

This application is based upon and claims priority from U.S. Provisional Patent Application No. 61/712,759, filed Oct. 11, 2012, the entire disclosure of which is herein incorporated by reference.

### FIELD OF THE INVENTION

This invention generally relates to electronic information systems, and more specifically to information processing systems and computer-implemented methods for providing a physician referral network.

### BACKGROUND OF THE INVENTION

When a physician determines that a patient needs to be seen by one or more other healthcare providers, the physician currently must manually refer the patient to the other healthcare providers. For example, a primary care physician examines a patient and determines that the patient's condition requires the care of a specialist physician. The primary care physician then personally or through an office staff person refers the patient to an appropriate specialist physician in the area. This is done by giving the patient the name of the specialist physician so that the patient or a family member must contact the office of that or another self-chosen specialist physician to make an appointment, or by someone in the physician's office manually contacting the office of the specialist physician to make an appointment for the patient. This can also be done by the physician filling out a paper form for the referral in triplicate. The form is then faxed to the specialist by the physician's office or the patient manually takes the form to the specialist in order to set up the appointment with the specialist.

In another example, a specialist physician examines a patient and determines that the patient's condition requires tests to be performed by a healthcare business such as a diagnostic center (e.g., to get an MRI). The specialist physician then personally or through an office staff person refers the patient to an appropriate diagnostic center in the area by giving the patient the name of the diagnostic center or by manually contacting the diagnostic center to make an appointment for the patient. Thus, the patient or someone at the physician's office must take the time and effort to manually make an appointment to see the other healthcare provider.

Additionally, it is common that after going to see another healthcare provider to which a patient was referred, the patient does not return to the referring primary care physician for follow-up care. For example, the patient could believe that a specialist physician is treating their medical condition or has successfully treated their medical condition, so that there is no reason to go back to the primary care physician. Likewise, a specialist physician or healthcare business could refer the patient on to another specialist physician or healthcare business for further treatment, or may even refer the patient to another primary care physician.

In all of these cases, the referring physician does not receive the results of the additional medical care to which the patient was referred. In fact, the referring physician does not even know if the patient actually went through with getting the additional medical care from the healthcare provider. This situation leads to inefficiency because the referring physician does not have all of the information to coordinate the patient's medical care. And in some cases this situation leads to extra expense and potential harm to the patient, and can result in duplicative or redundant medical care. Further, the referring physician loses revenue by not having one or more follow-up office visits with the patient. The referring physician can even lose the patient entirely to another competing physician, and thus all future revenue from the patient.

The lack of follow-up care can even produce a dangerous situation in which a life-threatening condition is left untreated. The patient could mistakenly believe that the specialist physician or healthcare business automatically sends their diagnosis or results back to the referring physician. This typically causes the patient to assume that the referring physician reviewed the results and will contact them for follow-up care if any is necessary. If the results were never received by the referring physician, the patient's medical condition will not receive the proper treatment.

### SUMMARY OF THE INVENTION

One embodiment of the present invention provides a computer-implemented method for using a physician referral network to refer a patient from a physician to another healthcare provider. According to the method, there is received, via the physician referral network, a request from the physician for an appointment calendar of the other healthcare provider. The appointment calendar of the other healthcare provider is sent via the physician referral network to the physician. The appointment calendar includes information indicating days and times of open appointments. An appointment request is received via the physician referral network from the physician for an appointment for the patient with the other healthcare provider. The appointment request indicates the day and time of one of the open appointments from the appointment calendar of the other healthcare provider. After receiving the appointment request, a notification of the appointment with the other healthcare provider is sent to the patient. Both the physician and the other healthcare provider are registered members of the physician referral network.

Another embodiment of the present invention provides a system for providing a physician referral network for referring a patient from a physician to another healthcare provider. The system includes at least one processor programmed to perform the following. There is received, via the physician referral network, a request from the physician for an appointment calendar of the other healthcare provider. The appointment calendar of the other healthcare provider is sent via the physician referral network to the physician. The appointment calendar includes information indicating days and times of open appointments. An appointment request is received via the physician referral network from the physician for an appointment for the patient with the other healthcare provider. The appointment request indicates the day and time of one of the open appointments from the appointment calendar of the other healthcare provider. After receiving the appointment request, a notification of the appointment with the other healthcare provider is sent to the patient. Both the physician and the other healthcare provider are registered members of the physician referral network.

A further embodiment of the present invention provides a computer-readable medium encoded with a computer program for using a physician referral network to refer a patient from a physician to another healthcare provider. The computer program contains instructions for performing the following. There is received, via the physician referral network, a request from the physician for an appointment calendar of the other healthcare provider. The appointment calendar of the other healthcare provider is sent via the physician referral network to the physician. The appointment calendar includes information indicating days and times of open appointments. An appointment request is received via the physician referral network from the physician for an appointment for the patient with the other healthcare provider. The appointment request indicates the day and time of one of the open appointments from the appointment calendar of the other healthcare provider. After receiving the appointment request, a notification of the appointment with the other healthcare provider is sent to the patient. Both the physician and the other healthcare provider are registered members of the physician referral network.

Other objects, features, and advantages of the present invention will become apparent from the following detailed description. It should be understood, however, that the detailed description and specific examples, while indicating exemplary embodiments of the present invention, are given by way of illustration only and various modifications may naturally be performed without deviating from the present invention.

### BRIEF DESCRIPTION OF THE DRAWINGS

FIG. 1 is a block diagram illustrating the overall system architecture of a physician referral network according to one embodiment of the present invention;

FIG. 2 is a block diagram of components of the server of FIG. 1 according to one embodiment of the present invention;

FIGS. 3A-3D are block diagrams showing more detail of selected components of FIG. 2 according to one embodiment of the present invention;

FIG. 4 is a flowchart showing a process for joining a physician referral network according to one embodiment of the present invention;

FIG. 5 is a flowchart showing a patient referral process in a physician referral network according to one embodiment of the present invention;

FIG. 6 shows a member directory interface according to one embodiment of the present invention;

FIG. 7 shows a calendar interface according to one embodiment of the present invention;

FIG. 8 shows an appointment creation interface according to one embodiment of the present invention; and

FIG. 9 is a block diagram of a computer system useful for implementing embodiments of the present invention.

### DETAILED DESCRIPTION

Exemplary embodiments of the present invention will be described in detail hereinbelow with reference to the attached drawings.

Embodiments of the present invention provide a computer-implemented physician referral network that allows physicians or other healthcare providers to connect and refer patients to one another and to healthcare providers, while holding healthcare providers to which patients are referred accountable to the referral relationship. One embodiment of the present invention allows a referring physician to make an appointment for a patient on another healthcare provider's calendar, and to hold the other healthcare provider accountable if the patient is not sent back to the referring physician for follow-up care. Additionally, in this embodiment the patient and the physician receiving the referral both receive one or more notifications via in-system electronic messaging (e.g., emails, text messages, or other electronic communications) of the referral appointment so that the patient has clear knowledge of the details of the referral appointment and is responsible for following through on the appointment.

In this embodiment, a referring physician using the network has access to the appointment calendar of the other healthcare provider (e.g., physician) to greatly assist in the referral appointment scheduling process. The patient or someone in the referring physician's office no longer has to manually make an appointment with the other healthcare provider because the appointment is made by the referring physician through the physician referral network. Thus, physicians using the physician referral network of the present invention reduce their overhead costs in marketing and referral development, and are assisted in forming strong referral relationships that help to grow their practice.

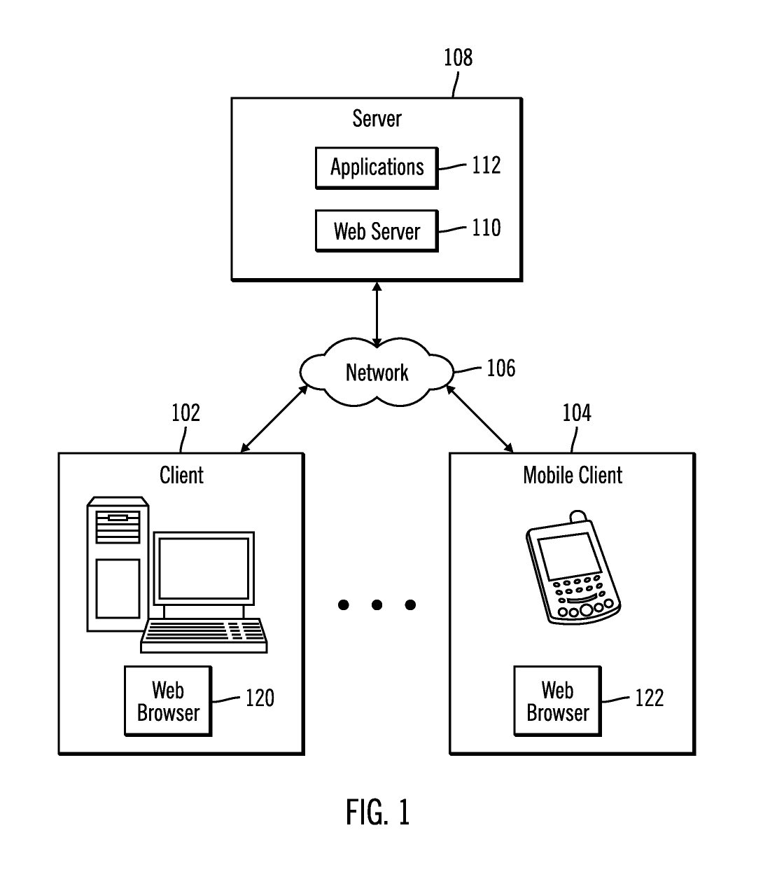

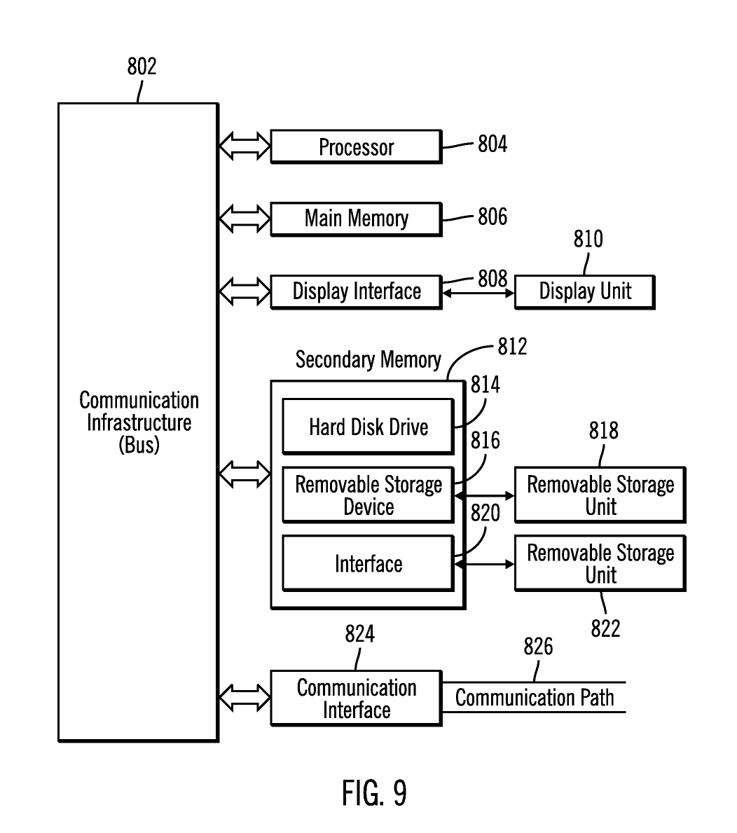

FIG. 1 is a block diagram illustrating the system architecture of a physician referral network according to one embodiment of the present invention. As shown, the physician referral network includes multiple client electronic devices 102 through 104, which are utilized by a user to navigate websites and/or execute applications. The physician referral network also includes a server 108. In this embodiment of the present invention, the client devices 102 through 104 and server 108 are personal computers (e.g., desktop computers, mobile computers, or workstations, such as IBM or compatible PC computers running the Microsoft Windows operating system or Macintosh computers running the Mac OS operating system, or the like), cloud-based systems, personal digital assistants, tablets or other hand-held computers, smart phones, game consoles, and/or any other information processing devices. In the illustrated embodiment, exemplary client device 102 is a desktop computer and exemplary client device 104 is a mobile device (e.g., a tablet or smartphone). An exemplary computer system for client devices 102 through 104 and server 108 is described in greater detail below with reference to FIG. 9.

In the illustrated embodiment, the server 108 is any commercially available server system that allows the server 108 and client devices 102 through 104 to exist in a web server-browser relationship in which web pages and information are served to the client devices when they visit and navigate through a website provided by the server 108. In an alternative embodiment, the server 108 is any commercially available server system that allows client devices 102 through 104 to exist in a client-server relationship with the server 108. For example, the server 108 can be a server system (e.g., one or more SUN workstations running the Solaris operating system or IBM Power System servers running the AIX or Linux operating system). The server 108 can be implemented on a single computer system or on multiple computer systems located in one or multiple locations, such as a mobile computer, a desktop computer, a workstation, a cloud-based system (e.g., a server cloud), a server, a data center, a mainframe computer-based system or the like.

In the illustrated embodiment of the present invention, the network 106 is a circuit switched network (such as the Public Service Telephone Network (PSTN)), or a packet switched network (such as the global Internet, a private wide area network (WAN), or a local area network (LAN)), another telecommunications network whether or not now in existence, or any combination of the above-mentioned networks. The network can be a wired network, a wireless network, a broadcast network, a point-to-point network, a point-to-multipoint network, or any combination of these.

The physician referral network of the illustrated embodiment includes a website that connects physicians and other healthcare providers. As shown in FIG. 1, the server 108 of this embodiment includes a web server 110 and applications 112 that implement the website and the features of the physician referral network. The information necessary to serve the web pages of the website is stored on the server 108, such as on a hard disk or other computer-readable medium.

Additionally, a web browser 120 and 122 is located on each of the client computers 102 through 104. The web browser can be any commercially available web browser, such as Chrome, Firefox, Internet Explorer, Safari, or the like. The web browser interacts with the web server 110 running on the server 108 to display the web pages of the website to the user of the client device (e.g., a desktop computer, or a mobile device such as a smartphone or tablet). The user interacts with the web pages displayed in the web browser to use features of the physician referral network. Additionally or alternatively, the client devices (e.g., desktop computers and/or mobile devices such as a smartphones and tablets) include client-side applications (stand-alone (native) applications and/or applications operating within a web browser) that interact with server-side applications running on the server 108 in a client-server relationship to implement features of the physician referral network.

The physician referral network of the illustrated embodiment provides a social networking platform that allows physicians to professionally refer their patients to other healthcare providers in an easy and virtual way, and then get these patients back into their practice for follow-up medical care. The physician referral network connects the physicians in a private, secure, and professional online setting, allowing them to securely share information with one another and to easily refer their patients. A physician or healthcare provider using the physician referral network is able to search for specialist physicians and other healthcare businesses and organizations, and to refer patients to these other healthcare providers in an efficient, safe, and informative manner.

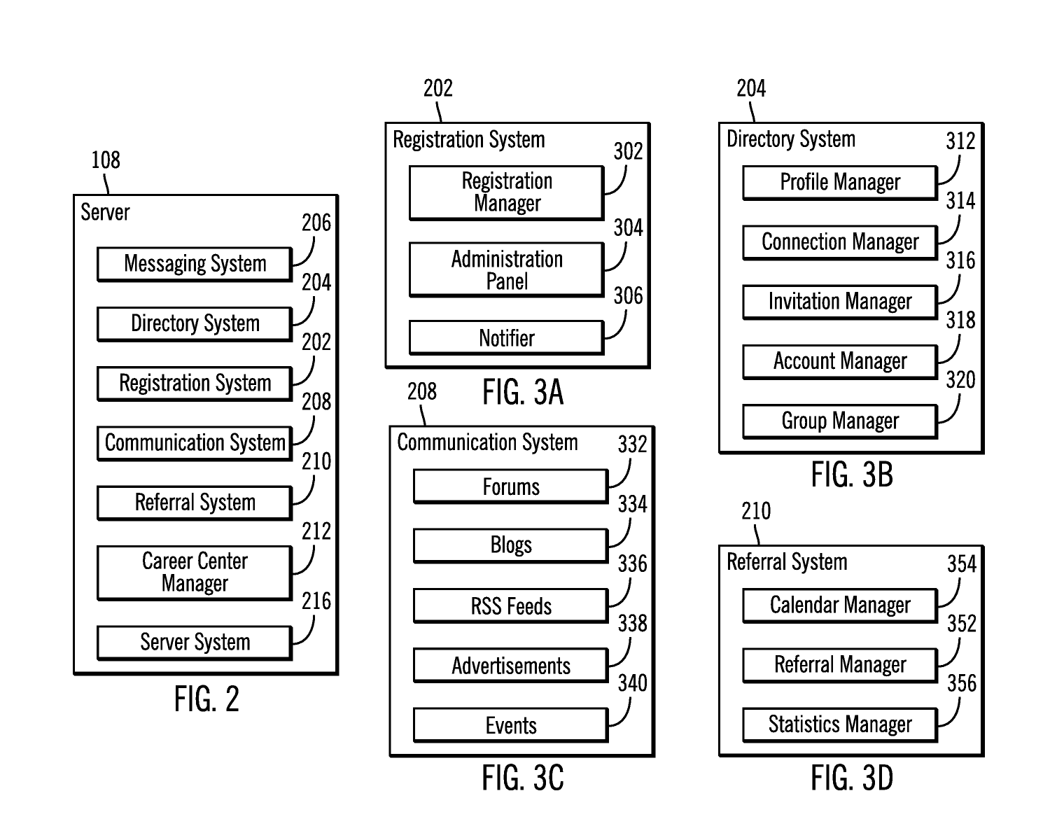

FIG. 2 is a block diagram of components of the server of FIG. 1 according to one embodiment of the present invention. These components are used to implement the physician referral network. As shown, the server 108 includes a server system 216. The server system 216 is a web server and/or server-side application that interacts with the other components to provide information (e.g., web pages) to the client devices. In the illustrated embodiment, the server system 216 provides a start (or home) page of the website to the client devices. The start page provides information about the physician referral network so that non-members can learn about the features of the physician referral network. The start page also contains links for accessing other features of the physician referral network, such as registration, member directory, referrals, and messages. When a user activates one of the links, the server system 216 interacts with the other components to provide the selected feature to the client device.

The server 108 also includes a registration system 202 that handles secure registration and payment for new members. FIG. 3A shows selected sub-components of the registration system 202. In this embodiment, a non-member physician or healthcare business receives an email invitation to join the network, from a member or the network itself. The invitation includes a link to the start page of the website. The non-member can review the information on the start page and then click on the registration link. A registration manager 302 of the registration system 202 then sends a secure registration form to obtain information from the prospective member. The prospective member completes the registration form in their web browser, including full name, address, email address, password, education, medical licenses, and any medical specialties. In this embodiment, the prospective member also has to successfully complete a Captcha form to prevent spam, and must accept the physician referral network's terms of use and service.

After successfully sending their registration information, the registration system also provides the prospective member (or any free member) with information regarding the benefits of a paid membership (i.e., subscription) to the physician referral network, including the ability to receive referrals, along with full access to the system's features and networking tools. The registration manager 302 prompts the prospective member to purchase a paid subscription in order to gain full access to the network's features (e.g., through a monthly, quarterly, semi-annual, or annual subscription payment).

In this embodiment, each prospective member is manually reviewed by an administrator of the network to verify all information provided including medical credentials. An administration panel 304 is used by the administrator to approve or deny prospective members. Once approved, a notifier 306 sends the physician or healthcare business an email (or other electronic communication such as an SMS text message) to notify of the approval. If the new member was invited to join by an existing member, the notifier also sends the existing member an email to notify of the successful registration that they facilitated. After being approved, the new member is given instant access to the features of the physician referral network to which they subscribed (e.g., free physician, paid physician, or healthcare business). The new member of the physician referral network can then login to their account at any time through the start page, by entering their registered email address and password.

As shown in FIG. 2, the server 108 also includes a directory system 204 that allows members to manage their personal account details and settings. FIG. 3B shows selected sub-components of the directory system 204. In this embodiment, the directory system provides each member with a member dashboard that contains links for managing personal account details and settings. Through the dashboard, the directory system 204 provides a profile manager 312 that facilitates the entering and editing of profile details such as name, avatar, current position, specialty, education, website, personal summary, practice information, work experience, publications, specialty certificates, languages spoken, and recommendations. In some embodiments, the administrator must review and approve some profile changes (e.g., education and specialty certificates).

In this embodiment, the member profile on the physician referral network includes a media gallery for uploading, editing, and deleting photos and videos. Comments and ratings can also be given to the photos and video. Keyword tags or captions can be added to allow improved searching. Additionally, the member profile also includes a user blog for making and managing member blog posts. Also provided is a user news feed that includes text updates, photo and video uploads, member comments, and posts from connected members.

The directory system 204 also includes a connection manager 314 that allows a member physician to manage connections with other member physicians. The connection manager 314 facilitates a two-way connection between two member physicians, which requires mutual acceptance. The member can send connection requests, approve or deny connection requests, and remove existing connections. Additionally, the connection manager 314 also facilitates following (i.e., one-way connections) of other members, which does not require any approval. The member physician can follow and unfollow other members.

An invitation manager 316 allows the member physician send an invitation to join the network to a non-member physician or healthcare business. An account manager 318 allows the member to change account settings such as avatar, password, and privacy and notification settings. The account manager 318 also allows the member to renew membership, upgrade to a paid membership, downgrade to a free membership, or cancel the account. A group manager 320 allows the member to create, join, and leave groups. Each group is structured as a private network within the physician referral network. The group has an avatar, title, description, and categorization. Group members can post text, photos, and videos to the group wall.

The directory system 204 also provides a calendar link for accessing the member's calendar, and a messaging link for accessing a messaging system 206 of the server 108. The messaging system 206 provides on-site conversational message threads between individual members of the physician referral network. In this embodiment, an email notification is sent when a new message is received, subject to the member's notification settings. Optionally, an SMS or other type of electronic notification can be additionally or alternatively sent when a message is received.

The server 108 also includes a communication system 208 that handles various types of system-wide communications. FIG. 3C shows selected sub-components of the communication system 208. In this embodiment, forums 332, blogs 334, RSS feeds 336, advertisements 338, and events 340 are provided. The forums 332 are standard forums with administrator-controlled categories and sub-categories. Members initiate discussion topics and can post comments on existing discussion topics. The blogs 334 are standard text or multimedia blogs with titles, and content and keyword tags. Members can make blog posts, and rate and comment on existing blog posts. The posts are displayed chronologically with links to the author's profiles. The RSS feeds are standard news feeds that provide links to external news sources (e.g., RSS feeds).

The advertisements 338 provide an area for posting advertisements (e.g., classified ads) to advertise products and services that are available. A member can post advertisements with links back to their profile. Each posted advertisement may require a fee, or all or a certain number of posts may be included with a paid membership. Also, non-member entities may be allowed to post an advertisement for a fee. The events 340 allow posting of events such as conferences that are of interest to the physician community. In one embodiment, the latest blog entries, forum posts, and RSS feed links are shown on the start page.

The server 108 also includes a referral system 210 that handles the referral process of the physician referral network. FIG. 3A shows selected sub-components of the referral system 210. In this embodiment, all member physicians can refer a patient, but only a paid member physician can receive a referral. Additionally, a healthcare business can receive a referral, but cannot send referrals.

A referral manager 352 works with a calendar manager 354 and the messaging system 206 to implement a patient referral process according to an embodiment of the present invention. When a referral is made, the referral manager causes the messaging system to send an on-site message to the member receiving the referral. When the on-site message is sent, the message recipient also receives an electronic notification (e.g., email and/or SMS notification), subject to the member's notification settings. The referral manager 352 also enforces rules to make sure that referred patients are returned to the referring physician in order to protect member physicians from losing patients. The referral manager 352 includes customizable form messages (such as thank you letters, follow-up letters, and update letters). These preloaded letters assist physicians and allow them to add in personal branding.

A statistics manager 356 keeps track of important statistics. For example, in this embodiment the statistics manager 356 tracks the number of invitations sent by a member that successfully convert to new member registrations, and the number of referrals that a member sends and receives over a period of time. A member can view these tracked statistics. The statistics manager 356 also gives referral analytics that allow a member physician to see who they refer to the most and who refers to them the most. This information allows them to see how the physician referral network is working for them and how they can strategically adapt their referrals to benefit their practice. In this embodiment, the statistics manager 356 also provides other information such as details about referrals received (e.g., why the referrals were given), and location information regarding referrals. This other information can be used for data mining (e.g., to compute the density of referrals according to geographic locations, to compute the number of referrals for a given treatment or condition, and so on). Additionally, in this embodiment, a paid member can view a list of the members that have viewed their profile.

The calendar manager 354 provides the member calendar and allows referral appointments to be created and approved. Each member has an appointment calendar. A member can create appointments in their own calendar. The details of these appointments remain private, showing on the member's calendar only as blocks that are occupied. The member can also search for appointments on the calendar, and can add general text about appointment availability that is displayed along with their calendar.

The calendar manager 354 allows a physician member to view the calendars and appointment availability of paid members (physicians and healthcare businesses) in their personal network (i.e., with whom they are connected). The appointment calendar indicates days and times of current appointments and open appointments. A paid member's calendar displays currently available and unavailable appointment blocks to physician members in their personal network. A physician member makes a referral by creating a referral appointment in a free block of time (i.e., open appointment) on the calendar of a paid member in their personal network. In this embodiment, the referral appointment includes information such as member name, patient name, patient email and phone number, desired appointment date and time, office location and phone number, and the referring physician's name (with a link to the referring physician's profile). Some of this information is auto-filled in from the profiles of the members involved.

When a referral appointment is made, the member receiving the referral receives an email with a summary of the appointment in this embodiment. Alternatively, the member can receive an on-site message about the appointment, and email and/or SMS notifications of the on-site message. In the illustrated embodiment, the member must log into the network to approve the appointment, deny the appointment, or edit the appointment. Alternatively, a form email or SMS message could be used to approve or deny the appointment. When an appointment is approved, a confirmation email with a summary of the appointment is sent to the patient, the referring physician, and the physician receiving the referral.

The server 108 also includes a career center manager 212 that provides a career center containing job listings. The career center manager 212 interacts with the messaging system 206 to allow members to message back and forth about job listings, including the exchanging of documents such as resumes. In this embodiment, all member physicians can view job listings, but only recruiters and paid member physicians can create job listings. Further, recruiters must pay a fee and cannot access the physician directory. Instead, member physicians must contact the recruiter if interested in a job listing. Similarly, in this embodiment, healthcare businesses cannot access the physician directory.

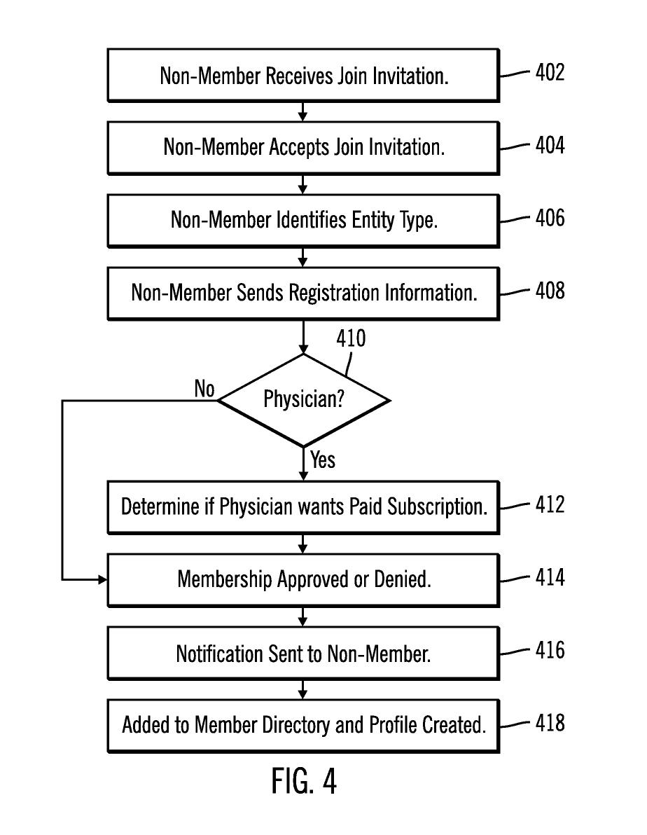

FIG. 4 is a flowchart showing a process for joining a physician referral network according to one embodiment of the present invention. At step 402, a non-member physician or healthcare business receives invitation to join the physician referral network via an electronic communication, from a member or the network itself. In this embodiment, the join invitation is sent through the website of the physician referral network to the non-member's email address via a single email invite form or via an advanced email importer for mass emailing. At step 404, the non-member accepts the join invitation, such as by clicking on a link in the join invitation.

At step 406, the non-member identifies their entity type. In this embodiment, entity types include physician, healthcare business, healthcare organization, and recruiter. A healthcare business is any medical business or practitioner to which a physician refers patients (e.g., a diagnostic center, lab, physical therapist, or home healthcare nurse). A healthcare organization is a society of physicians (e.g., the AMA or an organization of specialty physicians). At step 408, the non-member sends registration information to the network, such as by completing a registration form for their entity type in their web browser.

At step 410, it is determined if the entity type is physician. If so, then at step 412, the non-member indicates whether or not they want to purchase a paid subscription. In this embodiment, healthcare businesses and recruiters must pay a monthly or annual fee to become members, while physicians can choose between a free membership and a paid membership. Only physicians with a paid membership can receive referrals and create job listings. A healthcare organization is given free membership, but can only access professional networking features of the physician referral network (e.g., the forums, blogs, and physician directory). Payment information is collected for those member types that require a fee.

While in this embodiment only physicians that receive referrals must pay a membership fee, in another embodiment all physicians must pay a membership fee to join the network. In some embodiments, a fee is charged based on referrals. In one such embodiment, a basic paid membership includes the ability to connect with five other members who will refer patients, and additional fees are charged for connecting with additional members who will refer patients. Typically, if a physician gets another physician to join the network as a fee-paying member, then that new member connection will not count towards their connections.

Further, all physicians and healthcare businesses must agree to abide by the referral rules of the network. If a member does not follow the rules regarding referrals and keeps a referred patient or sends them back to a different physician, action is taken. For example, in one embodiment, after two reacquiring complaints by referring physicians, a member is warned of a potential loss of privileges. A further reacquiring complaint causes the member to lose privileges, either for a set time or permanently. This holds all members that use the physician referral network accountable to the other members of the network.

At step 414, the non-member is approved or denied for membership. In this embodiment, prospective members are manually reviewed by an administrator of the network to verify information such as medical credentials. Alternatively, an automatic process or a peer review process by other members can be used to approve or deny membership. At step 416, the non-member is notified of the approval or denial via an electronic communication. If the join invitation was sent by an existing member and membership is approved, the existing member also receives a notification via an electronic communication of the successful registration and the possibility of requesting a connection with the new member. In one embodiment, a unique tracking code is included in the join invitation in order to allow the existing member to be notified.

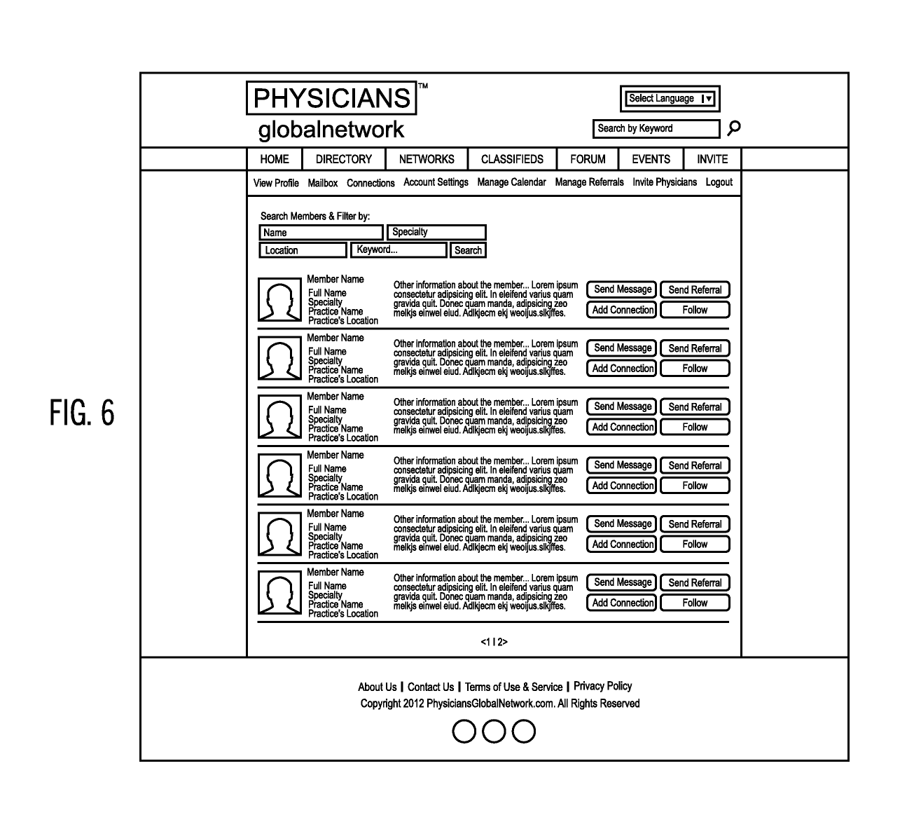

At step 418, the new member is added to the searchable member directory and a member profile is created. FIG. 6 shows a member directory interface according to one embodiment of the present invention. Physician members can search the member directory using fields such as name, location, specialty, and keyword. After finding a member in the directory, a physician can send a message to the member, request a connection with the member, follow the member, or send a referral to the member. In some embodiments, two members must be connected prior to a referral being sent.

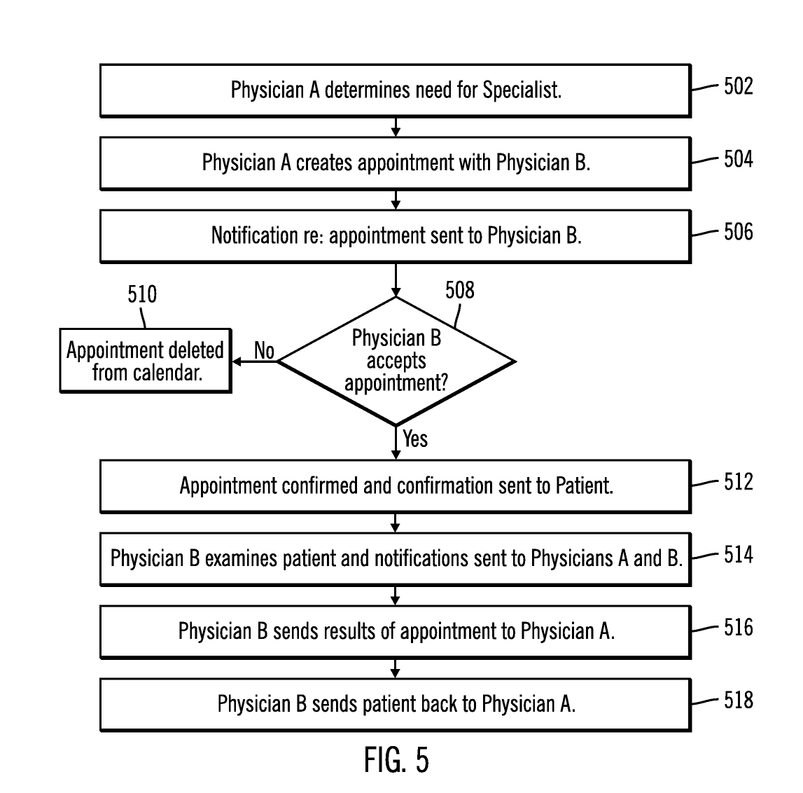

FIG. 5 is a flowchart showing a patient referral process in a physician referral network according to one embodiment of the present invention. This exemplary process illustrates the referral of a patient from Physician A (e.g., a primary care physician) to Physician B (e.g., a specialist physician). Both physicians are paid, registered members of the physician referral network and they have a two-way connection.

At step 502, Physician A examines the patient and determines that the patient needs further care from a specialist for a specialized condition. Physician A notifies the patient of the need for a specialist and explains that the patient will be referred to a specialist.

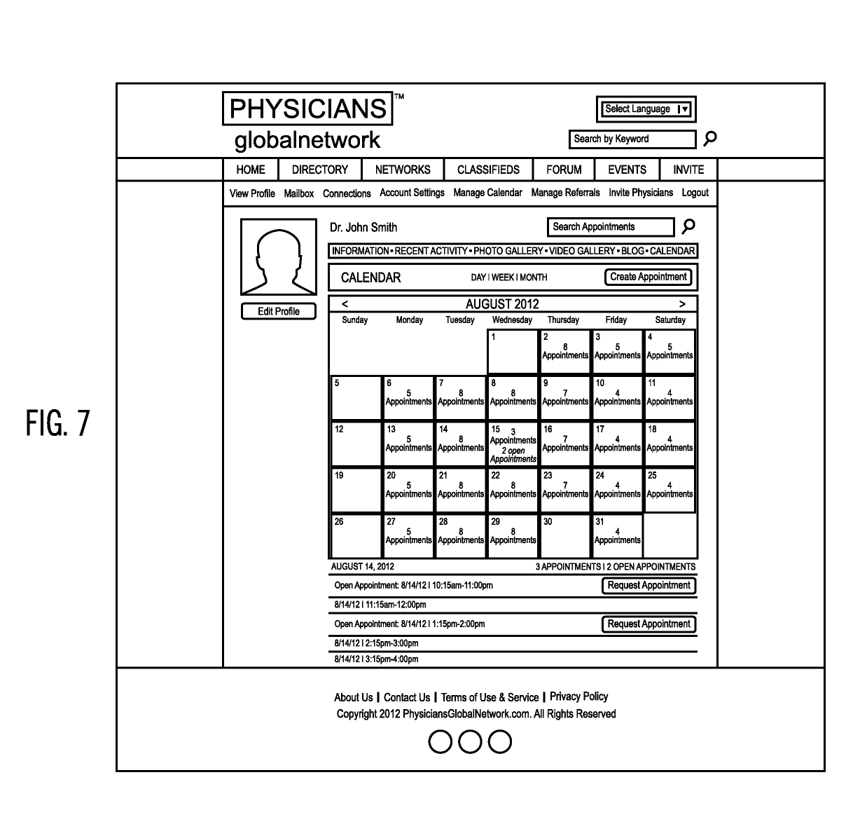

At step 504, Physician A creates an appointment on the calendar of Physician B via the physician referral network. In this embodiment, Physician A (personally or through an office staff person) opens the website of the physician referral network, logs in, and reviews the specialist physicians that are in the network of (i.e., connected to) Physician A. After choosing Physician B, Physician A (personally or through an office staff person) opens Physician B's calendar. This is done by requesting the appointment calendar of Physician B, which causes the physician referral network to send the appointment calendar of Physician B to Physician A. The appointment calendar indicates days and times of current appointments and open appointments. FIG. 7 shows a calendar interface according to one embodiment of the present invention. As shown, the calendar interface identifies open appointment slots. An open appointment slot for Physician B is chosen and an appointment request for an appointment for the patient with Physician B is sent. The appointment request indicates the day and time of one of the open appointments from the appointment calendar of Physician B.

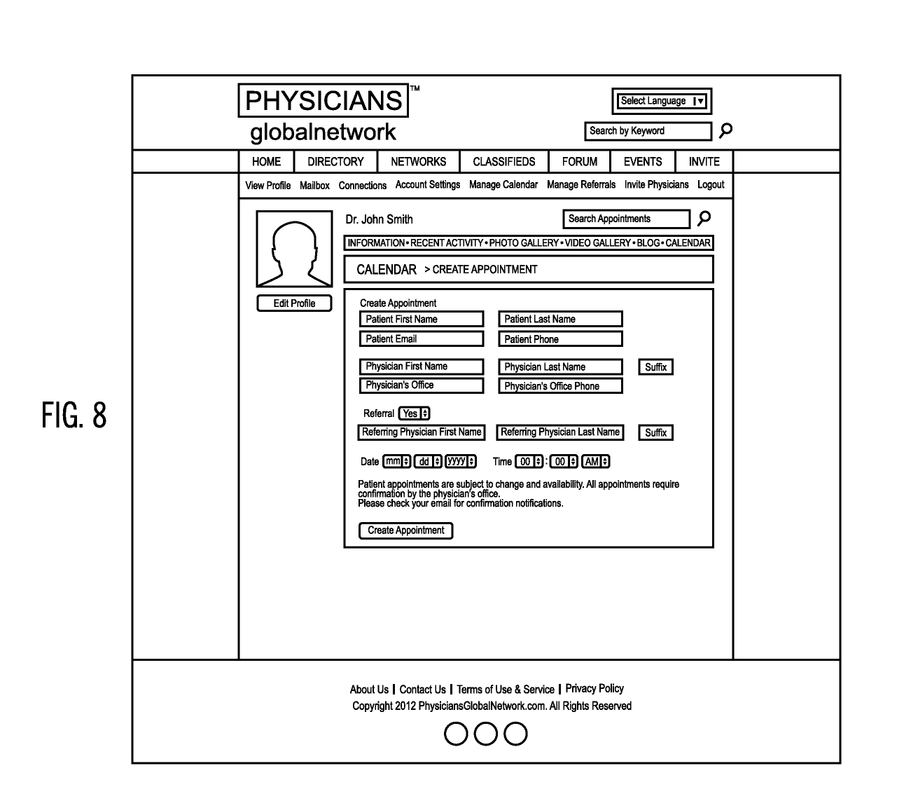

FIG. 8 shows an appointment creation interface according to one embodiment of the present invention. As shown, the patient's name and information, Physician A's name and information, Physician B's name and information and the desired appointment time is entered to create an appointment. Information for the physicians is automatically filled-in from their profiles. Information for the patient is taken from the patient's records and/or is collected from the patient. In some embodiments, patient information can be imported and saved for reuse. Thus, the patient leaves Physician A's office with a scheduled appointment for Physician B.

After the appointment is created via the calendar, a notification is sent to Physician B at step 506. A notification is optionally also sent to the patient at this time. In this embodiment, one or more electronic communications (e.g., email, text message (such as SMS or MMS), and/or on-site message) are sent to Physician B to notify of the patient referral from Physician A and the need for a confirmation within 24 hours. The patient's information is included for Physician B's records and prior insurance authorization if necessary.

At step 508, Physician B (personally or through an office staff person) opens the website of the physician referral network, logs in, and decides whether or not to accept the appointment. If Physician B does not accept the appointment, then at step 510 the appointment is deleted form Physician B's calendar and notifications are sent to Physician A and the patient via electronic communications. On the other hand, if Physician B accepts the appointment, then at step 512 the appointment is confirmed and an electronic notification (e.g., email and/or SMS confirmation) of the appointment is sent to the patient. This confirmation message includes Physician B's office address and information, the appointment time, and the cancelation protocol in order to fully inform the patient. In this embodiment, a thank you message for the referral is also sent to Physician A via an electronic communication.

At step 514, the scheduled appointment occurs with Physician B examining and treating the patient. Additionally, notifications regarding the appointment are sent to Physicians A and B via electronic communications. In this embodiment, an email and/or on-site message is automatically sent to Physician A regarding the occurrence of the appointment and the need to follow-up with the patient. Another email and/or on-site message is automatically sent to Physician B regarding the need to send the results to Physician A.

At step 516, Physician B sends an electronic communication (e.g., email and/or on-site message) to Physician A with a basic description of what was done to the patient at the appointment, and recommendations for further care or office visits if necessary. This insures communication between the two physicians so that the patient is treated appropriately and does not receive duplicative care. This is very advantageous in the new healthcare environment because it eliminates treating the patient multiple times with the same treatment because of non-communication. Further, in this embodiment if Physician B does not send the results, Physician A can send a message to request them. The post-appointment notification sent to Physician A is useful to remind Physician A the results are needed. Alternatively, periodic notifications regarding the need to send results to Physician A can be automatically sent via electronic communications until Physician B sends the results.

After Physician B has finished treating the patient, Physician B sends the patient back to Physician at step 518. In this embodiment, Physician B makes a follow-up appointment on Physician A's calendar on the physician referral network. Alternatively, Physician B can send an electronic communication (e.g., email and/or on-site message) to Physician A (e.g., through the original appointment link) to let Physician A know that the patient is ready for follow-up care by Physician A. If Physician B does not return the patient to Physician A (e.g., by making a follow-up appointment with Physician A or sending a message to Physician A regarding the need for follow-up care), Physician A can register a complaint on the physician referral network. In this embodiment, the number of complaints against a physician is shown only on their private profile, which cannot be viewed by anyone except the physician. In another embodiment, any paid member that has a two-way connection can view the number of complaints against a physician.

In this embodiment, after a set number of complaints (e.g., three) are registered against a physician, the physician is suspended or permanently barred from the physician referral network (e.g., loses his registration/account, or just cannot receive referrals permanently or for a given amount of time). Warning notifications can be sent to a physician before suspension, and a physician may be given a chance to remedy a complaint. For example, in one embodiment a notification is sent that the results of the appointment have not been sent back to the referring physician. The physician is given a set amount of time to rectify the complaint (e.g., by sending the results of the appointment) before the complaint becomes effective. In some embodiments, complaints are investigated by an administrator of the physician referral network, and a physician can be removed after a set number of verified complaints. In some embodiments, complaints expire after a given time, or a given number of complaints must be made (and optionally verified) within a given time for a member to be sanctioned. Thus, the physician referral network enforces strict rules to protect member physicians from losing patients. This protects the member physician's future revenue.

Alternatively or additionally to sending the results of the appointment, Physician B can use the appointment calendar of Physician A and send an appointment request for a follow-up appointment for the patient with Physician A, This also insures that the patient is returned to Physician A.

Further, in this exemplary embodiment, the sending of the appointment request and the sending of the notice of the appointment to the patient are performed during the original appointment of the patient with Physician A (e.g., before the patient leaves Physician A's office). Thus, the physician referral network allows Physician A to schedule an appointment for the patient with Physician B before the patient leaves Physician A's office. This puts Physician A to control the scheduling of the referral appointment, and eliminates the need for the patient to schedule their own appointment. This also prevents the patient from failing to follow through with the scheduling of the referral appointment, thus increasing the chances that Physician A's patient will get the necessary further treatment. The patient leaves the original appointment with Physician A already having an appointment scheduled with Physician B.

Accordingly, the physician referral network of the present invention connects physicians and their medical practices. The physician referral network provides a solution for virtually referring patients to other healthcare providers and then getting these patients back to the original referring physician. A referring physician can identify a specialist physician, request that the specialist physician join the referring physician's network, and refer patients directly to the specialist physician. After the specialist physician has seen the patient, the specialist physician can send the patient back to the original referring physician to help maintain a strong and healthy referral network. The enforcement of referral rules in the physician referral network of the present invention holds all members that use the physician referral network accountable to the other members of the network.

The physician referral network of the present invention also helps to network with other physicians. The referral network of the present invention allows two physicians to connect and refer patients to each other on a virtual platform. This platform limits the need for additional marketing and overhead that practice development brings to a physician's everyday practice. A clear and safe business environment is provided in which the physician can refer out patients with greatly decreased risk of losing the patient. In other words, a physician can refer a patient to a connected and trusted healthcare provider without a low risk of losing that patient to another physician who does not respect the referral relationship and keeps the patients. The physician referral network of the present invention assists physicians or other healthcare providers in developing their practice through referrals via personal networks established through the physician referral network.

In one embodiment, the physician referral network of the present invention is a professional network that allows physicians to obtain paid membership and then exchange referrals through the network via mutual connections with other physicians, aided by physician profiles. There is no need to download software or use it through a cloud.

The present invention can be realized in hardware, software, or a combination of hardware and software. A system according to the present invention can be realized in a centralized fashion in one computer system, or in a distributed fashion where different elements are spread across several interconnected computer systems. Any kind of computer system—or other apparatus adapted for carrying out the methods described herein—is suitable. A typical combination of hardware and software is a general-purpose computer system with a computer program that, when loaded and executed, controls the computer system such that it carries out the methods described herein.

Embodiments of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer program product on a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

FIG. 9 is a block diagram of a computer system useful for implementing embodiments of the present invention. The computer system of FIG. 9 includes one or more processors, such as processor 804. The processor 804 is connected to a communication infrastructure 802 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 808 that forwards graphics, text, and other data from the communication infrastructure 802 (or from a frame buffer not shown) for display on the display unit 810. The computer system also includes a main memory 806, preferably random access memory (RAM), and may also include a secondary memory 812. The secondary memory 812 may include, for example, a hard disk drive 814 and/or a removable storage drive 816, representing a floppy disk drive, a magnetic tape drive, an optical disk drive, etc. The removable storage drive 816 reads from and/or writes to a removable storage unit 818 in a manner well known to those having ordinary skill in the art. Removable storage unit 818, represents, for example, a floppy disk, magnetic tape, optical disk, etc. which is read by and written to by removable storage drive 816. As will be appreciated, the removable storage unit 818 includes a computer usable storage medium having stored therein computer software and/or data.

In alternative embodiments, the secondary memory 812 may include other similar means for allowing computer programs or other instructions to be loaded into the computer system. Such means may include, for example, a removable storage unit 822 and an interface 820. Examples of such may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to the computer system.

The computer system may also include a communications interface 824. Communications interface 824 allows software and data to be transferred between the computer system and external devices. Examples of communications interface 824 may include a modem, a network interface (such as an Ethernet card), a communications port, a PCMCIA slot and card, etc. Software and data transferred via communications interface 824 are in the form of signals which may be, for example, electronic, electromagnetic, optical, or other signals capable of being received by communications interface 824. These signals are provided to communications interface 824 via a communications path (i.e., channel) 826. This channel 826 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 806 and secondary memory 812, removable storage drive 816, a hard disk installed in hard disk drive 814, and signals. These computer program products are means for providing software to the computer system. The computer readable medium allows the computer system to read data, instructions, messages or message packets, and other computer readable information from the computer readable medium. The computer readable medium, for example, may include non-volatile memory, such as Floppy, ROM, Flash memory, Disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allows a computer to read such computer readable information.

Computer programs (also called computer control logic) are stored in main memory 806 and/or secondary memory 812. Computer programs may also be received via communications interface 824. Such computer programs, when executed, enable the computer system to perform the features of the present invention as discussed herein. In particular, the computer programs, when executed, enable the processor 804 to perform the features of the computer system. Accordingly, such computer programs represent controllers of the computer system.

The illustrated embodiment of the present invention relates to a web server-browser implementation. However, in further embodiments the physician referral network of the present invention is implemented in other ways. For example, some embodiments use a cloud-based implementation (e.g., using Amazon Web Service) or a data-center based implementation. Similarly, a mainframe computer system could be used to implement the physician referral network of the present invention.

Further, the physician referral network of the present invention can be implemented as an addition to an existing social or professional network (such as Facebook, LinkedIn, Doximity, ZocDoc, Sermo, ReferralMD, CareCloud, an Electronic Medical Records (EMR) system, or an Electronic Referral Management (ERM) System). In one such embodiment, the physician referral network is a referral exchange application that is accessed through such a social or professional network site to enable referrals between network members. The physician referral network of the present invention can also be implemented as a web service (e.g., using REST, SOAP, and/or WSDL web service protocols). Additionally, the physician referral network of the present invention can be implemented in a mobile-only manner (i.e., without requiring a corresponding web-based application). Such an implementation allows a physician to refer a patient in the same manner as described above with respect to the web-based system, but through a mobile device and a downloadable application. This provides mobile capability for patient referral in the physician professional network of the present invention.

In general, the physician referral network of the present invention is implemented through a software system that is designed to support interoperable machine-to-machine interaction over a network (e.g., as defined by the world-wide-web consortium).

Additionally, other design choices, such as the fee structure could easily be adapted by one of ordinary skill in the art. For example, in further embodiments, the fee structure includes other fees and/or fee offsets (e.g., referral credits, pay-as-you-refer, and so on).

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

What is claimed is:

1. A computer-implemented method for using a physician referral network to refer a patient from a physician to another healthcare provider, the method comprising the steps of:
receiving, via the physician referral network, a request from the physician for an appointment calendar of the other healthcare provider;
sending, via the physician referral network, the appointment calendar of the other healthcare provider to the physician, the appointment calendar including information indicating days and times of open appointments;
receiving, via the physician referral network, an appointment request from the physician for an appointment for the patient with the other healthcare provider, the appointment request indicating the day and time of one of the open appointments from the appointment calendar of the other healthcare provider; and
after the step of receiving the appointment request, sending a notification of the appointment with the other healthcare provider to the patient,
wherein the physician and the other healthcare provider are both registered members of the physician referral network.

2. The method of claim 1, wherein the steps of receiving the appointment request and sending the notice of the appointment to the patient are performed during an appointment of the patient with the physician.

3. The method of claim 1, wherein the appointment calendar sent to the physician includes information indicating days and times of current appointments and open appointments.

4. The method of claim 1, wherein the physician is a primary care physician and the other healthcare provider is a specialist physician.

5. The method of claim 1, further comprising the steps of:
sending, via the physician referral network, an electronic notification of the appointment request to the other healthcare provider;
receiving, via the physician referral network, an acceptance of the appointment request from the other healthcare provider; and
after the step of receiving the acceptance, sending, to the patient and the physician, a confirmation of the appointment for the patient with the other healthcare provider.

6. The method of claim 1, further comprising the steps of:
after the appointment of the patient with the other healthcare provider, determining whether results of the appointment were sent from the other healthcare provider to the physician; and
when it is determined that the other healthcare provider did not send the results of the appointment to the physician, sending, via the physician referral network, a notification to the other healthcare provider that the results of the appointment have not been sent to the physician.

7. The method of claim 6, further comprising the steps of:
after the step of sending the notification to the other healthcare provider, repeating the determining step; and
when, after the determining step is repeated, it is determined that the other healthcare provider still did not send the results of the appointment to the physician, recording a complaint against the other healthcare provider.

8. The method of claim 7, further comprising the step of:
after a determined number of complaints against to the other healthcare provider have been recorded, preventing the other healthcare provider from receiving referrals from the physician referral network.

9. A computer-implemented method for using a referral network to refer a patient from a first healthcare provider to a second healthcare provider, the method comprising the steps of:
sending, via the referral network, an appointment calendar of the second healthcare provider to the first healthcare provider, the appointment calendar including information indicating days and times of open appointments;
receiving, via the referral network, an appointment request from the first healthcare provider for an appointment for the patient with the second healthcare provider, the appointment request indicating the day and time of one of the open appointments from the appointment calendar of the second healthcare provider;
sending a notification of the appointment request to the second healthcare provider;
receiving an acceptance of the appointment request from the second healthcare provider;
sending, to the patient and the first healthcare provider, a notice of the appointment for the patient with the second healthcare provider; and
after the appointment of the patient with the second healthcare provider, at least one of:
receiving, via the referral network, results of the appointment from the second healthcare provider, and sending, via the referral network, the results of the appointment to the first healthcare provider; and
sending, via the referral network, an appointment calendar of the first healthcare provider to the second healthcare provider, and receiving, via the referral network, an appointment request from the second healthcare provider for a follow-up appointment for the patient with the first healthcare provider,
wherein the first healthcare provider and the second healthcare provider are both registered members of the referral network.

10. The method of claim 9, further comprising the steps of:
after the appointment of the patient with the second healthcare provider, determining whether the results of the appointment were sent from the second healthcare provider to the first healthcare provider; and
when it is determined that the second healthcare provider did not send the results of the appointment to the first healthcare provider, sending, via the referral network, a notification to the second healthcare provider that the results of the appointment have not been sent to the first healthcare provider.

11. The method of claim 10, further comprising the steps of:
after the step of sending the notification to the second healthcare provider, repeating the determining step; and
when, after the determining step is repeated, it is determined that the second healthcare provider still did not send the results of the appointment to the first healthcare provider, recording a complaint against the second healthcare provider.

12. The method of claim 11, further comprising the step of:
after a determined number of complaints against to the second healthcare provider have been recorded, preventing the second healthcare provider from receiving referrals from the referral network.

13. The method of claim 9, wherein the step of receiving the appointment request is performed during an appointment of the patient with the first healthcare provider.

14. A system for providing a physician referral network for referring a patient from a physician to another healthcare provider, the system comprising:
at least one processor programmed to:
receive a request from the physician for an appointment calendar of the other healthcare provider;
send the appointment calendar of the other healthcare provider to the physician, the appointment calendar including information indicating days and times of open appointments;
receive an appointment request from the physician for an appointment for the patient with the other healthcare provider, the appointment request indicating the day and time of one of the open appointments from the appointment calendar of the other healthcare provider; and
after receiving the appointment request, send the patient a notification of the appointment with the other healthcare provider,
wherein the physician and the other healthcare provider are both registered members of the physician referral network.

15. The system of claim 14, wherein the receiving of the appointment request and the sending of the notice of the appointment to the patient are performed during an appointment of the patient with the physician.

16. The system of claim 14, wherein the appointment calendar sent to the physician includes information indicating days and times of current appointments and open appointments.

17. The system of claim 14, wherein the physician is a primary care physician and the other healthcare provider is a specialist physician.

18. The system of claim 14, wherein the at least one processor is further programmed to:
send an electronic notification of the appointment request to the other healthcare provider;
receive an acceptance of the appointment request from the other healthcare provider; and
after the receiving of the acceptance, send, to the patient and the physician, a confirmation of the appointment for the patient with the other healthcare provider.

19. The system of claim 14, wherein the at least one processor is further programmed to:
after the appointment of the patient with the other healthcare provider, determine whether results of the appointment were sent from the other healthcare provider to the physician; and
when it is determined that the other healthcare provider did not send the results of the appointment to the physician, send a notification to the other healthcare provider that the results of the appointment have not been sent to the physician.

20. The system of claim 19, wherein the at least one processor is further programmed to:
after the sending of the notification to the other healthcare provider, again determine whether the results of the appointment were sent from the other healthcare provider to the physician;
when, after again determining that the results of the appointment were not sent to the physician, record a complaint against the other healthcare provider; and
after a determined number of complaints against to the other healthcare provider have been recorded, prevent the other healthcare provider from receiving referrals from the physician referral network.

21. A non-transitory computer-readable medium encoded with a computer program for using a physician referral network to refer a patient from a physician to another healthcare provider, the computer program containing instructions for performing the steps of:
receiving, via the physician referral network, a request from the physician for an appointment calendar of the other healthcare provider;
sending, via the physician referral network, the appointment calendar of the other healthcare provider to the physician, the appointment calendar including information indicating days and times of open appointments;
receiving, via the physician referral network, an appointment request from the physician for an appointment for the patient with the other healthcare provider, the appointment request indicating the day and time of one of the open appointments from the appointment calendar of the other healthcare provider; and
after the step of receiving the appointment request, sending the patient a notification of the appointment with the other healthcare provider,
wherein the physician and the other healthcare provider are both registered members of the physician referral network.

22. The non-transitory computer-readable medium of claim 21, wherein the steps of receiving the appointment request and sending the patient the notice of the appointment are performed during an appointment of the patient with the physician.

23. The non-transitory computer-readable medium of claim 21, wherein the computer program further contains instructions for performing the steps of:
sending, via the physician referral network, an electronic notification of the appointment request to the other healthcare provider;
receiving, via the physician referral network, an acceptance of the appointment request from the other healthcare provider; and
after the step of receiving the acceptance, sending, to the patient and the physician, a confirmation of the appointment for the patient with the other healthcare provider.

24. The non-transitory computer-readable medium of claim 21, wherein the computer program further contains instructions for performing the steps of:
after the appointment of the patient with the other healthcare provider, determining whether results of the appointment were sent from the other healthcare provider to the physician; and
when it is determined that the other healthcare provider did not send the results of the appointment to the physician, sending, via the physician referral network, a notification to the other healthcare provider that the results of the appointment have not been sent to the physician.

25. The non-transitory computer-readable medium of claim 24, wherein the computer program further contains instructions for performing the steps of:
after the step of sending the notification to the other healthcare provider, repeating the determining step;
when, after the determining step is repeated, it is determined that the other healthcare provider still did not send the results of the appointment to the physician, recording a complaint against the other healthcare provider; and
after a determined number of complaints against to the other healthcare provider have been recorded, preventing the other healthcare provider from receiving referrals from the physician referral network.
